(19) United States
(12) Patent Application Publication
(10) Pub. No.: US 2019/0063704 A1
(43) Pub. Date: Feb. 28, 2019

(54) IR LIGHT FOR A VEHICLE

(71) Applicant: Rainer DIEDERICH, Reichshof-Denklingen (DE)

(72) Inventor: Rainer DIEDERICH, Reichshof-Denklingen (DE)

(21) Appl. No.: 15/690,766

(22) Filed: Aug. 30, 2017

(51) Int. Cl. F21S 41/13; H05B 33/08; B60Q 1/24; F21S 41/141; B60Q 1/076; B60Q 1/08

(52) U.S. Cl. CPC F21S 41/13; H05B 33/0845; B60Q 1/085; F21S 41/141; B60Q 1/076; B60Q 1/24

(57) ABSTRACT

The invention relates to an IR light device for a vehicle, comprising at least one source of IR light, and a control unit for controlling the at least one source of IR light for performing one of a plurality of possible light functions in the operating mode selected. Light function selection information can be supplied from an external source to the control unit for selecting the light function, and operating mode selection information can be supplied from an adjusting device to the control device for selecting the operating mode.

The invention relates to an IR light for a vehicle, in particular for a quad or an off-road vehicle.

Lights for vehicles are generally known in various shapes. Whereas most vehicle lights operate in the visible range, infrared (IR) light devices are of particular interest in certain applications. In combination with a night-vision device, IR light devices may be used e.g. in vehicles to make the road and objects thereon visible also in the darkness. Such systems comprising IR light devices may be useful in particular for a hunter hunting in the darkness, but also for security personnel having to monitor an area or woodland in the darkness.

Besides IR headlights, IR rear lights are often desirable as well. This is the case in particular when a team of people travels in the darkness with several vehicles and the individual members of the team wish to be able to recognize each other and communicate with each other, without people that are no members of the team being able to recognize them and to eavesdrop on their communication. For example, a security team may include a plurality of persons, each driving a vehicle equipped with IR light devices and each team member having a night-vision device. Thus, only the members of the security team are able to recognize the vehicles of the other team members. Since the demands on IR headlights often differ from the demands on IR rear lights, in particular with respect to the output powers, different lights would have to be used at the front and the rear of the vehicle.

It is an object of the invention to provide an IR light device for a vehicle that can perform different light functions. It is another object of the invention that the IR light device can be used both as an IR front light and as an IR rear light.

The above mentioned object is achieved, according to the invention, with an IR light device for a vehicle comprising
at least one source of IR light,
a control unit for controlling the at least one source of IR light for performing one of a plurality of possible light functions in the operating mode selected,
wherein light function selection information can be supplied from an external source to the control unit for selecting the light function, and
wherein operating mode selection information can be supplied from an adjusting device to the control device for selecting the operating mode.

It is an advantage of the IR light device of the present invention is the availability of a variety of light functions which may on the one hand serve to illuminate objects and may on the other hand also allow communication between different participants.

The IR light source may be a single source, but may also be a combination n of a plurality of individual IR light sources. In particular, it may be provided that the IR light source is dimmable so that its brightness or intensity can be adjusted if so desired. The adjusting device may preferably be manually operated so that a user of the IR light device can set the operating mode in which the IR light device is to operate. In particular, it may be possible to select an operating mode of the IR light device in which it is operated as a vehicle front light or a vehicle rear light or as a flashlight. The additional control unit serves to activate the concrete light device function in one of the above-mentioned operating modes. The light device functions may in particular be a low-beam light function, a high-beam light function, an indicator light function, an emergency signal function, a rear light function or a brake light function. Further, different brightness functions and other encoded signals may be provided.

In an advantageous embodiment the IR light device of the present invention may advantageously be adapted for use as both a vehicle front light and a vehicle rear light. Depending on which of the two operating modes is desired, it is possible to set this operating mode using the adjusting device, each operating mode offering certain light device functions designed for the corresponding mode.

The IR light device may be used both as an IR front light device and as an IR rear light device of a vehicle, while the desired operating mode can simply and conveniently be selected via the preferably manual adjusting device. Thereby, it is no longer necessary to provide different IR light devices for the front and rear sides of a vehicle and to further provide different replacement light devices for the front and rear sides of a vehicle. Besides the lighting function, the IR light device of the present invention also provides further functions by means of which the different drivers may e.g. communicate with each other.

In a preferred embodiment of the IR light device of the invention it may be provided that the light device functions include at least two intensity functions and/or at least one blinking function and/or at least one function for emitting an encoded signal. Here, the different intensity functions may be realized e.g. by dimming the intensity of the IR light source. If a plurality of IR light sources exists, it may be provided that the intensity of all IR light sources is controll4ed or that the number of activated IR light sources is varied and the intensity of the individual activated IR light sources remains constant. Here, the intensity of an IR light source may preferably be adjusted using pulse width modulation. As an alternative, it may be provided that the intensity of an IR light source is adjusted by controlling a supply source. The outputted encoded signal may in particular be a SOS signal, a special warning signal warning participants of a specific danger, or a retreat signal. In this respect, the intensity functions my preferably provide intensities of the at least one IR light source that provide 1%, 20%, 50% or 100% of the maximum intensity of the at least one IR light source. For the blinking function it may be provided that different blinking rates may be adjusted, wherein it is possible for the different drivers to also communicate with each other through the rate of the blinking signals. In a preferred embodiment of the IR light device of the present invention it may be provided that the light device function selection information is selectable by using at least one operating element arranged in the vehicle. Here, a direction indicator, a brake pedal or an accelerator pedal of a vehicle may serve as an operating element. It may also be provided that a rotary adjuster serves as the operating element, the rotary adjuster being explicitly designed for controlling the IR light device. Preferably, the light device function selection information is supplied to the IR light device via a line. It may also be provided that the transmission of the light device function selection information to the IR light device is performed in a wireless manner (e.g. via a Bluetooth link).

It may further be provided in a development of the IR light device of the present invention that the IR light source comprises at least one IR LED. It is the advantage of the use of IR LEDs that these are particularly easy to control and, in addition, available at low cost. Here, it is possible to use in particular high-performance LEDs with power inputs of several Watt. Besides conventional LEDs designed as wired components, it is also possible to use SMD-LEDs (SMD=Surface Mounted Device) either exclusively or in combination with conventional LEDs. Contrary to the conventional wired LEDs, the power input and the optical output of SMD-LEDs is often lower. Therefore, it is advantageous to use wired LEDs and SMD LEDs in combination in an IR light device. Thus, it is possible e.g. to activate the SMD-LEDs if a particularly low output is desired, whereas the high-performance LEDs are activated e.g. if a particularly high output is desired. The IR light device of the present invention thus offers a very wide operational range and is therefore suited to generate both very low outputs and very high outputs. Since significantly lower outputs of the IR light device are usually required for IR rear light devices than for an IR front light device, the IR light device of the present invention, which includes both wired LEDs and SMD-LEDs, is suited both for an operating mode as a front light and an operating mode as a rear light.

In one embodiment of the invention it may be provided that the at least one IR LED has an emission wavelength of 880 nm, 840 nm, 850 nm, 890 nm, 940 nm or 950 nm. It becomes apparent that LEDs with the above-mentioned emission wavelengths are particularly well suited for the applications of the above described IR light device. In particular, LEDs having the above-mentioned emission wavelengths show a particularly good suitability in combination with night-vision devices.

In a further development of the invention it may be provided that the adjusting device comprises a switch. This switch which is manually operable, may in particular be a DIP switch (DIP=Dual In-Line Package). DIP switches have the advantage that their structure is very simple and that they are available at low cost. Thus, a DIP switch may be used to perform a preadjustment of the IR light device. A DIP switch generally comprises one or a plurality of sliding switches or lever switches that can each assume two positions. For example, with a bipolar DIP switch having two lever switches, a total of four possible operating modes can be selected, and with a four-pole DIP switch having four lever switches, a total of 16 different operating modes can be selected. By using a switch, in particular a DIP switch, which is preferably attached on a circuit board on which the LEDs are arranged as well, it becomes possible to adjust the operating mode of the IR light device in a most simple manner.

In a particularly preferred embodiment of the IR light device of the present invention it may be provided that the control device comprises a microcontroller. In this case the microcontroller serves to guarantee the desired light device function in a previously selected operating mode. In particular, it may be provided that the microcontroller controls one or a plurality of drivers that are provided for the operation of one or a plurality of LEDs. The use of a microcontroller has the advantage that the same can be programmed in a simple and flexible manner and is available at low cost. The microcontroller may be designed for adjusting the intensity of one or a plurality of IR light sources or for controlling the IR light sources with a blinking light signal or a differently encoded signal (SOS signal, warning signal, interference signal).

In a preferred embodiment of the invention it may be provided that the IR light device comprises an IR light filter. In this case the IR light source is arranged behind the IR light filter so that a certain part of the IR light spectrum is filtered out. An IR light filter as disclosed in DE 10 2012 024 773 A1 is particularly suited as the IR light filter. By using such a filter, it is possible to adjust the emission spectrum of the IR light device such that it is optimized for use with a night-vision device.

Moreover, it may be provided in a preferred embodiment of the IR light device of the invention that the IR light comprises an IR light source housing with at least one sealing element. The IR light source housing protects the IR light device in particular against dirt and dust. The sealing element used also serves to protect the IR light device from humidity and water. As the sealing element, O-rings are particularly well suited, the O-rings being clamped between two parts of the IR light source housing and thereby preventing ingress of water and humidity.

Further, it may be provided in the IR light device that also flashlight mode may be selectable. In this case the flashlight mode may provide special light device functions that are especially useful when the IR light device is used as a flashlight. In particular, these may include various intensity functions, a blinking light and a stroboscope function, emergency signal functions and warning functions.

Further, according to the invention, an IR-light device for use as a flashlight is provided, comprising
at least one source of IR light,
an adjusting device for selecting an operating mode of the IR light device as a vehicle front light or a vehicle rear light,
a control unit for controlling the at least one IR light source to perform one of a plurality of possible light device functions,
a housing adapted to be docked to the IR light device,
an operating element for selecting the light device functions of the IR light device, and
an energy source for current supply to the IR light device,
wherein light device function selection information can be supplied from the operating element to the control unit for the selection of a light device function, and
wherein operating mode selection information can be supplied from the adjusting device for the selection of the operating mode.

In this embodiment of the IR light device of the present invention, the current supply is no longer provided by the vehicle, but by an independent power source. The power source may in particular be an accumulator. Moreover, in this embodiment the light device function selection information is no longer supplied externally, i.e. typically from the vehicle, but from the operating element which preferably is arranged on the dockable housing. The IR light device is thus suited for use in combination with a vehicle, as well as separately as a flashlight.

Further, to achieve the above-mentioned object, a vehicle, in particular a quad, is provided which has an IR light device as described above. It is an advantage of such a vehicle that it no longer depends on different replacement light devices for use as front lights or rear lights. In addition, the vehicle of the invention offers various light device functions that are not only suited for lighting a road and objects on a road, but also for communication with other drivers.

The invention will be described in detail hereunder with reference to two embodiments and to the drawings. The Figures specifically show:

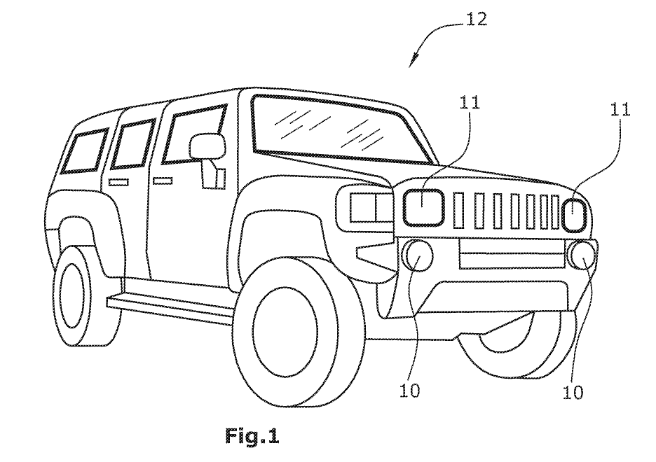

FIG. 1 an off-road vehicle with four front lights,

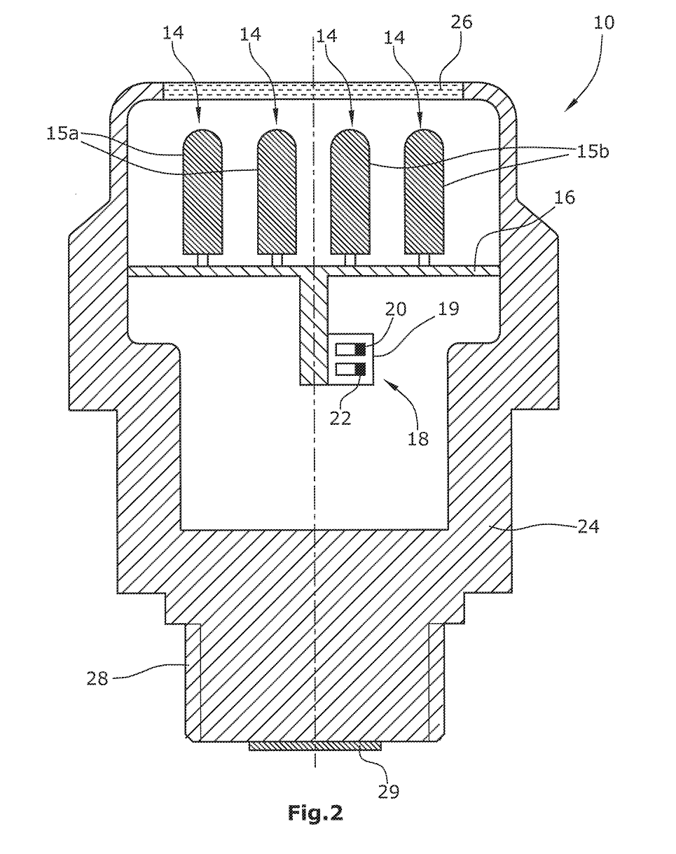

FIG. 2 a cross section of a first embodiment of the IR light device of the present invention with IR light sources arranged on a circuit board,

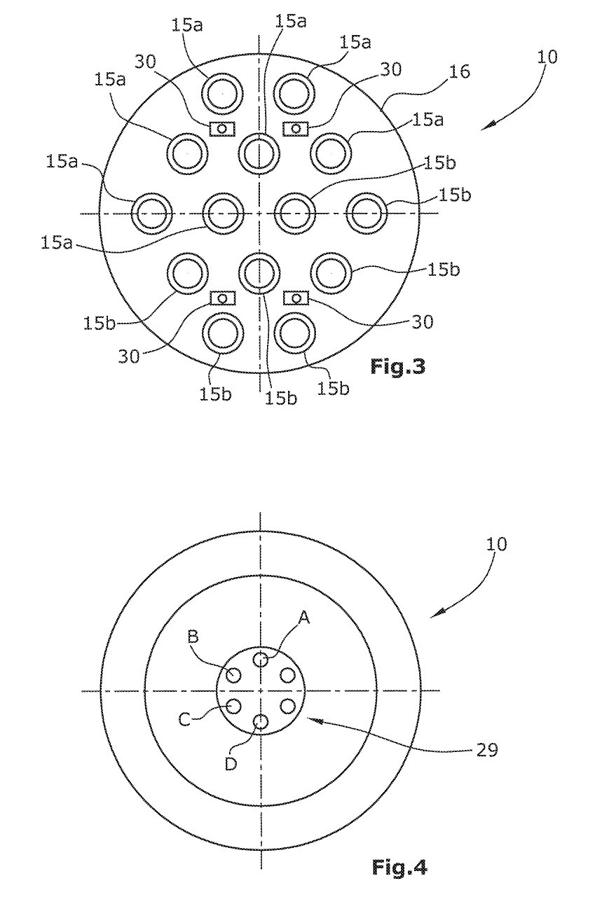

FIG. 3 a top plan view on the circuit board illustrated in FIG. 2 with IR light sources arranged on the circuit board,

FIG. 4 a rear view of the IR light device with six electrical connectors,

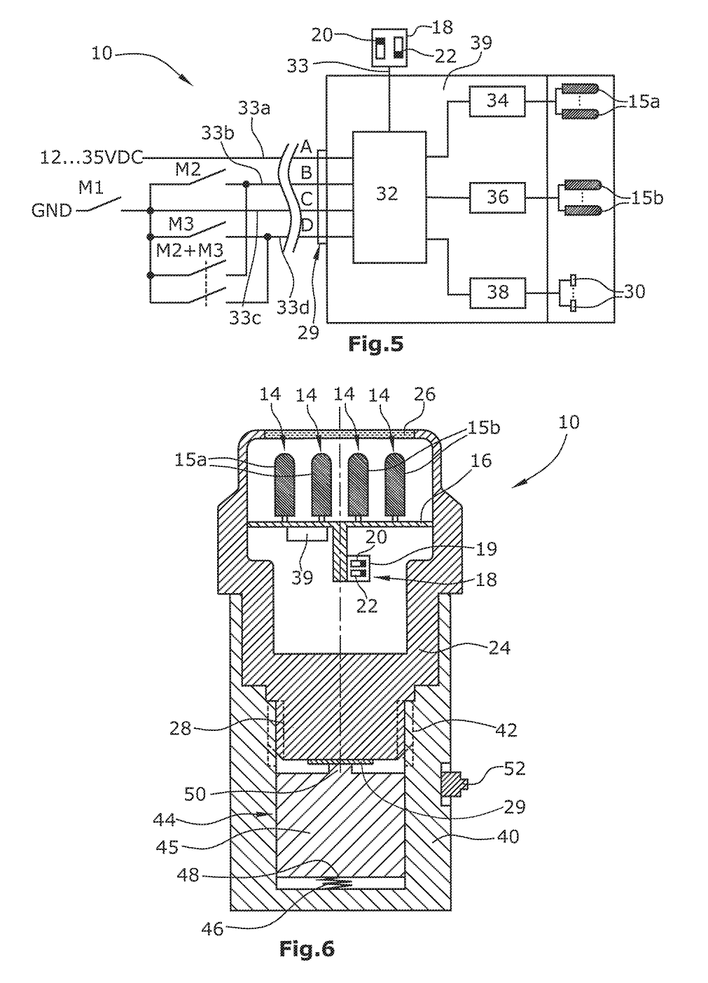

FIG. 5 a schematic illustration of the IR light device illustrated in FIG. 2, and

FIG. 6 a second embodiment of the IR light device of the present invention with a flashlight housing.

FIG. 1 illustrates two IR light devices 10 of the present invention installed in an off-road vehicle 12 below two conventional visible light devices 11.

FIG. 2 is a cross sectional view of one of the IR light devices 10 illustrated in FIG. 1. In this cross-sectional view four IR light sources 14 are shown which, in this embodiment, are configured as wired LEDs 15a, 15b. These LEDs 15a, 15b are arranged on a circuit board 16. In this embodiment the LEDs 15a, 15b do not differ in structure. They are merely divided into the two sets of the LEDs 15a and the LEDs 15b, since the individual sets of LEDs 15a, 15b can be controlled independently in this embodiment.

An adjusting device 18 is also mounted on the circuit board 16, the device being designed as a DIP switch 19 in the present embodiment. The DIP switch 19 illustrated is s bipolar DIP switch 19 with a first lever switch 20 and a second lever switch 22. Each of the two lever switches 20, 22 can assume two positions. Thus, the bipolar DIP switch 19 can be switched between a total of four different states. In the present embodiment of the IR light 10 of the present invention the different states can correspond to four different operating modes. The operating modes can, for instance, include a front light mode, a rear light mode and a flashlight mode. It is also possible that the operating modes comprise a plurality of front light modes, rear light modes or flashlight modes.

In the embodiment illustrated in FIG. 2, the essential components of the IR light device 10, namely the LEDs 15a, 15b, the circuit board 16 and the DIP switch 19 are situated in a light device housing 24. The light device housing 24 has an opening at one side, which is closed by a protective glass 26. In operation of the IR light device 10, the light generated by the LEDs 15a, 15b can exit through the protective glass 26. As an alternative, the protective glass 26 can also be replaced by an IR filter described above.

The light device housing 24 has a light device housing male thread 28 serving for connection with a vehicle or a flashlight housing. Using the light device housing male thread 28, the IR light device 10 can be connected with e.g. a vehicle 12 in short time and without requiring tools.

Further, a connector plug 29 is illustrated at the bottom side of the IR light device 10, in which plug individual connector terminals are arranged for voltage supply to and control of the IR light device 10.

FIG. 3 illustrates a top plan view on the circuit board 16 illustrated in FIG. 2. As can be seen in this Figure, a total of fourteen wired LEDs 15a, 15b and, in addition, four SMD LEDs 30 are arranged on the circuit board 16. Thus, a total of 18 LEDs 15a, 15b, 30 are located on the circuit board 16, which can be controlled as desired. For adjusting the total brightness of the IR light 10, it is possible to adjust the brightness of all LEDs or, as an alternative, to vary the total brightness by activating or deactivating individual LEDs 15a, 15b, 30. Since the wired LEDs 15a, 15b typically have a significantly higher output, these are preferably controlled when great brightness is desired. On the other hand, the SMD LEDs 30 are preferably controlled when only low outputs are desired, e.g. when the IR light device 10 is operated in the rear light mode and therefore, a low output is sufficient.

FIG. 4 shows a rear view of the IR light device 10 illustrated in FIG. 2. It can be seen in this Figure that the IR light device 10 has six electrical connectors on its rear side. In the present embodiment only four of these connectors are used to control the IR light sources. These four connectors A, B, C, D are externally supplied with light device function selection information for selecting the light device function. This information may e.g. be provided by connecting one or a plurality of the connector terminals A, B, C, D used to a ground potential. The light device function selection information is transmitted to a control unit not illustrated in FIG. 4. Depending on the light device function selection information, as well as on the operating mode selection information, the control unit can then provide the desired light device function.

FIG. 5 illustrates the principle of the control of the IR light device 10. As can be seen, the IR light device 10 comprises a microcontroller 32 which is supplied with operating mode selection information 33 and light device function selection information 33a, 33b, 33c, 33d. In the present embodiment, the operating mode selection information depends on the position of the two lever switches 20, 22 of the DIP switch 19. Further, in this embodiment, the light device function selection information 33a, 33b, 33c, 33d depends on the switching states of the switches M1, M2 and M3. It may e.g. be provided that, while the light device function selection information 33a always supplies a constant value, the values of the light device function selection information 33b, 33c, 33d depend on the switching positions of the switches M1, M2 and M3. These switches can e.g. be mounted on the vehicle and can be opened or closed by actuating operating elements located inside the vehicle. For example, switches M1, M2, M3 can be opened and closed by actuating an accelerator pedal, a brake pedal, a direction indicator or an operating element specifically designed for operating the IR light device 10. Depending on the operating mode selection information 33 and the light device function selection information 33a, 33b, 33c, 33d, the microcontroller 32 is able to control the drivers 34, 36, 38 such that the respective LEDs emit the desired brightness or the desired signal. In the present embodiment the drivers are configured such that the first driver 34 controls the brightness of the seven LEDs 15a, whereas the second driver 36 controls the brightness of the seven LEDs 15b and the third driver 38 controls the brightness of the four SMD LEDs 30.

The following table is an exemplary illustration of an assignment layout for the IR light device.

TABLE 1
assignment layout

| DIP switch | | M1 + M2 | M1 + M3 | M1 + M2 + M3 |
|---|---|---|---|---|
| pole 1/pole2 | M1 (C) | (C + B) | (C + D) | (C + B + D) |
| off/off | low beam | high beam | blinking | emergency |
| (front light) | light | light | light | signal |
| | (20% LED) | (100% LED) | | |
| off/on | reserve | reserve | reserve | reserve |
| off/on | reserve | reserve | Reserve | reserve |
| on/on | rear light | brake light | blinking | emergency |
| (rear light) | (50% SMD) | (1% LED) | light | light |

As is evident from Table 1, in this embodiment only two of the four possible switching states of the bipolar DIP switch are assigned. The other switching states are provided as reserve states, wherein one of the reserve states can be provided for the above mentioned flashlight mode. It is further evident from table 1 that four different light device functions can be selected in dependence on the states of the switches M1 to M3. Moreover, in this embodiment four different functions can be selected in the operating mode as a vehicle rear light. Specifically, it can be seen that in the operating mode as a vehicle rear light, significantly lower outputs are provided, namely e.g. 1% of the maximum LED power or 50% of the SMD LED power. The assignment layout is of purely exemplary nature. It is self-evident that the invention is not restricted to an assignment layout as illustrated in Table 1.

FIG. 6 illustrates a second embodiment of the IR light device 10 of the present invention which additionally comprises a flashlight housing 40. Here, the light device housing 24 is adapted to be threaded to the flashlight housing 40 by the male thread 28 of the light device housing and the female thread 42 of the flashlight housing. As an alternative, it is also possible that the light device housing 24 can be joined to the flashlight housing 40 by a bayonet lock. Thus, the IR light device 10 can be connected with the flashlight housing 40 in a simple and fast manner, and the IR light device 10 provided or a vehicle 12 can be converted into a flashlight within short. As illustrated in FIG. 6, an energy storage device 44 is located inside the flashlight housing 40, which device is designed as a battery 45 in this embodiment. The battery 45 is pressed against the connection plug 29 of the light device housing 24 by a helical spring 46, so that the first pole 48 of the battery 45 is pressed against the helical spring 46 and the second pole 50 of the battery 45 is pressed against the connection plug 29. The supply lines leading from the helical spring 46 and from the second pole 50 of the battery 45 to the corresponding connector terminals are not explicitly shown in FIG. 6.

In this embodiment an operating element 52 is arranged at one side of the flashlight housing 40, which element serves to select the light device function in the flashlight operating mode. By actuating the operating element 52, it is possible e.g. to select between different brightness levels, a stroboscope function and a warning light function. The supply lines leading from the operating element 52 to the corresponding connector terminals A, B, C, D are also not shown explicitly in FIG. 6.

### LIST OF REFERENCE NUMERALS

10 IR light device
11 visible light device
12 vehicle
14 IR light source
15a LED
15b LED
16 circuit board
18 adjusting device
19 DIP switch
20 lever switch
22 lever switch
24 light device housing
26 protective glass
28 male thread of light device housing
29 connection plug
30 SMD LED
32 microcontroller
33 operating mode selection information
33a light device function selection information
33b light device function selection information
33c light device function selection information
33d light device function selection information
34 driver
36 driver
38 driver
39 control unit
40 flashlight housing
42 female thread of flashlight housing
44 energy storage device
45 battery
46 helical spring
48 first pole of the battery
50 second pole of the battery
52 operating element
M1 switch
M2 switch
M3 switch
A connector terminal
B connector terminal
C connector terminal
D connector terminal

1-13. (canceled)

14. Infrared light device for a vehicle comprising
at least one source of infrared light,
a control unit configured for controlling the at least one source of infrared light for performing one of a plurality of possible light functions in an operating mode selected,
wherein light function selection information can be supplied from an external source to the control unit for selecting the light function, and
wherein operating mode selection information can be supplied from an adjusting device to the control unit for selecting the operating mode.

15. Infrared light device of claim 14, wherein the light device functions include at least two intensity functions and/or at least one blinking function and/or at least one function for emitting an encoded signal.

16. Infrared light device of claim 14, wherein the light function selection information is selectable by using at least one operating element arranged in the vehicle.

17. Infrared light device of claim 14, wherein the infrared light source comprises at least one infrared LED.

18. Infrared light device of claim 17, wherein the at least one infrared LED has an emission wavelength of 880 nm, 840 nm, 850 nm, 890 nm, 940 nm or 950 nm.

19. Infrared light device of claim 14, characterized by an adjusting device configured for selecting an operating mode of the infrared light device as a vehicle front light or a vehicle rear light.

20. Infrared light device of claim 17, wherein the adjusting device includes a switch.

21. Infrared light device of claim 14, wherein the control unit comprises a microcontroller.

22. Infrared light device of claim 14, characterized by an infrared filter which is arranged, seen from the at least one source of infrared light, in the emission direction of the same.

23. Infrared light device of claim 14, characterized by an infrared light source housing with at least one sealing element.

24. Infrared light device of claim 14, wherein a flashlight mode can also be selected as an operating mode.

25. Infrared light device for use as a flashlight is provided, comprising
at least one source of infrared light,
an adjusting device configured for selecting an operating mode of the infrared light device as a vehicle front light or a vehicle rear light,
a control unit configured for controlling the at least one source of infrared light to perform one of a plurality of possible light device functions,
a housing adapted to be docked to the infrared light device,
an operating element configured for selecting the light device functions of the infrared light device, and
an energy source for current supply to the infrared light device,
wherein light device function selection information can be supplied from the operating element to the control unit for the selection of a light device function, and
wherein operating mode selection information can be supplied from the adjusting device for the selection of the operating mode.

26. Vehicle with the infrared light device of claim 14.
